(19) United States
(12) Patent Application Publication
(10) Pub. No.: US 2006/0066233 A1
(43) Pub. Date: Mar. 30, 2006

(54) Display device for game machines

(76) Inventor: Haruo Inoue, Tokyo (JP)

Correspondence Address: Ronald E. Greigg;Greigg & Greigg, P.L.L.C., Unit One, 1423 Powhatan Street, Alexandria, VA, 22314, US

(21) Appl. No.: 10/948,216

(22) Filed: Sep. 24, 2004

(51) Int. Cl. H05B 33/00

(52) U.S. Cl. 313/511; 313/512; 313/506

(57) ABSTRACT

A display device with a plate shape for game machines includes a flexible EL element sheet; and one or more curved surface portions which are formed by inner and outer shape-support plates, capable of bringing the flexible EL element sheet and the inner and outer shape-support plates which sandwiches the flexible EL element sheet as a function for displaying into action. Therefore, it looks solid when the symbol is displayed on the display part which is formed in the flexible EL element sheet.

### FIELD OF THE INVENTION

This invention relates to a display device for game machines, which installed into the game machines including slot machines and pachinko machines.

### BACKGROUND OF THE INVENTION

The patent reference 1 (Japanese published unexamined application No. 7-114347) discloses the display device of a flexible EL (Electro Luminescence) element which has only one curved surface part. One kind of pixel pattern (display part for showing a symbol) is indicated by the above-mentioned curved surface part. However, since the display device is flexible in this patent reference 1, there is a problem that it cannot attach easily to the wide window part positioned the front of the game machine. Moreover, since it is one kind of pixel pattern, there is a problem that the contents of the display cannot be appealed with fun.

For the invention disclosed in the patent reference 2 (Japanese published unexamined application No. 2001-252393), there is a problem for a viewpoint of the efficiency of attachment and reduction of manufacturing cost since the display device is provided for every rotation reel on either side. For the invention disclosed in the patent reference 3 (Japanese published unexamined application No. 2004-105379), there is the same problem as the patent reference 2 since the organic EL display which is formed in the shape of a belt is wound around the outer circumferential surface of the rotation reel respectively.

### SUMMARY OF THE INVENTION

Accordingly, it is an object of the present invention to provide a display device for the game machines that can take out a cubic effect when a symbol is displayed on a display part and does not change the shape easily. It is another object of the present invention to provide a display device for the game machines that can attach easily to a wide window part positioned the front of a game machine (efficiency of attachment work). It is still another object of the present invention to provide a display device for the game machines which can use in order to display the different kind of information. It is further object of the present invention to provide a display device for the game machines that can reduce the manufacturing cost by arranging two or more first display parts which can display two or more rotation reels along with the winning-a-prize line of a symbol for example in the direction of a vertical section.

The display device for the game machines with the shape of a plate of this invention includes a flexible EL element sheet and at least one or more curved surface portions which allows the inner and outer shape-support plates bind and suport the flexible EL element sheet give the function as a display part.

In the above-mentioned composition, a shape-support plate is formed of a resin plate having a flat portion and a curved surface portion which provided continuously. Moreover, a plurality of the curved surface portions is formed in the shape-support plate. These curved surface portions, having the same curvature, are formed continuously in the direction of a vertical section, and the flat portion is formed into the curved surface portion positioned at the end portion thereof.

Moreover, the EL element sheet includes a first display part, which is formed in the shape of a cross-sectional arc, allowing a plurality of rotation reels give pseudo displaying and a second display part for displaying different contents from a rotation reel on a flat part thereof.

Moreover, the shape-support plate has a cover part which is formed in the shape of a “steamed fish paste”, which looks like a shape which is cut the hollow cylinder in half, and the first display part formed in the EL element sheet is covered by the cover part.

Moreover, the flat portion formed in the shape-support plate covers the second display part formed in the EL element sheet. Furthermore, the attachment portion which projects in the extended direction comparing with the size of the EL element sheet is formed in the both ends of the shape-support plate. In addition, the outer shape-support plate is transparent at least.

In this invention, “Display device” includes an EL element with a panel shape, EL element with a sheet shape, EL element with a film shape, organic EL display, etc. Moreover, “Bind” means to sandwich, wrap integrally and the like. Moreover, “Flat portion” means to position at a level state, inclination state and vertical state according to the position to the game machine. Therefore, the display device can also be used in the state that it is rotated at 90 degrees so that two or more curved surface portions are located in a line to the vertical direction.

The present invention is understood to encompass embodiments which include all or only a portion of the above objects, features and advantages which, unless recited in claims defining the invention, are understood not to limit interpretation of such claims. The above, and other objects, features and advantages of the present invention will become apparent from the following description read in conjunction with the accompanying drawings, in which like reference numerals designate the same elements.

It is to be expressly understood, however, that the drawings are for the purpose of illustration and description only, and are not intended as a definition of the limits of the invention.

### BRIEF DESCRIPTION OF THE DRAWINGS

FIGS. 1 to 10 illustrate the explanation view of the preferred embodiment of the present invention. FIGS. 11 and 12 illustrate the second embodiment of the present invention.

FIG. 1 is a schematic partially cut away view in front showing a first embodiment of the present invention;

FIG. 2 is a schematic cross-sectional view showing the way in which each member is expanded;

FIG. 3 is a exploded perspective view of each member;

FIG. 4 is a schematic explanation view of an EL element sheet;

FIG. 5 is a schematic diagram showing a relationship between inner and outer shape-support plates and an EL element sheet;

FIG. 6 is a schematic explanation view of a picture element pattern of a first display part;

FIG. 7 is a schematic explanation view of a picture element pattern of a second display part;

FIG. 8 is a schematic explanation view in perspective showing the way in which it is attached to a window part of the game machines;

FIG. 9 is a schematic explanation in front showing the way in which it is attached to a window part of the game machines;

FIG. 10 is a schematic explanation in vertical cross-section showing the way in which it is attached to a window part of the game machines;

FIG. 11 is a schematic partially cut away view in front showing a second embodiment of the present invention (figure as the same as FIG. 1); and

FIG. 12 is a schematic explanation in vertical cross-section showing the way in which it is attached to a window part of the game machines (figure as the same as FIG. 10).

### DETAILED DESCRIPTION OF THE PREFERRED EMBODIMENTS

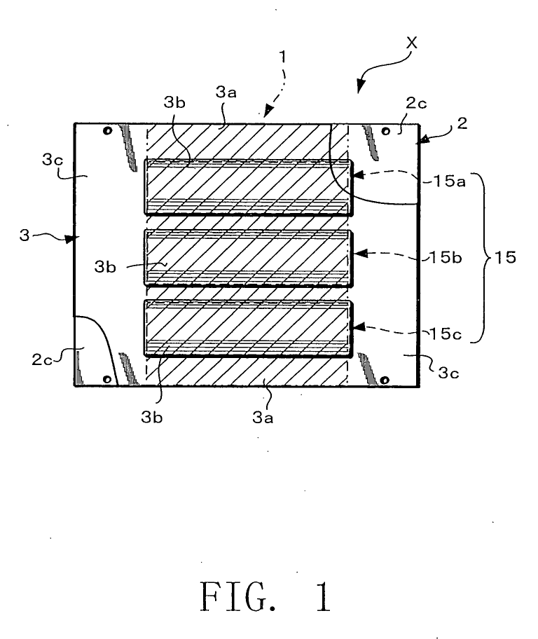

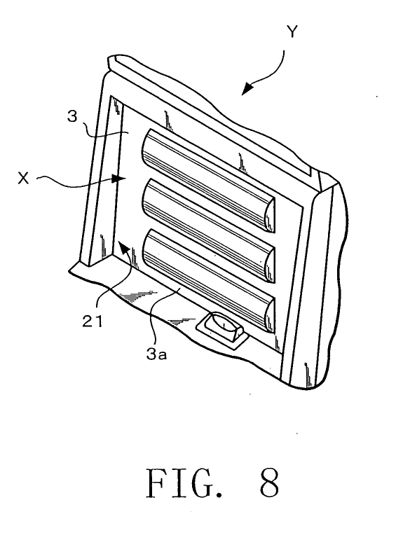

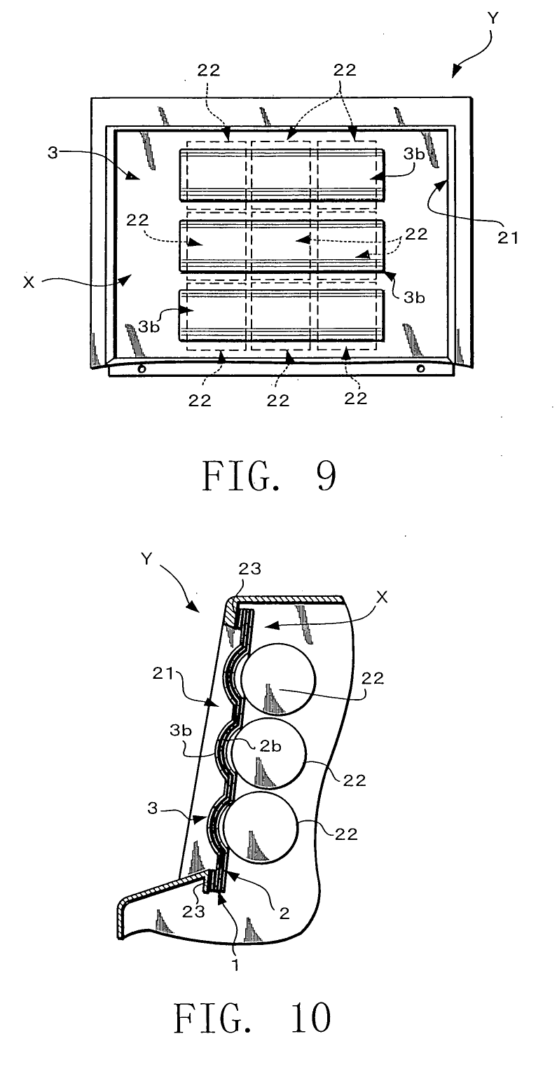

Preferred embodiment (the first embodiment) of the present invention is described in more detail below referring to FIGS. 1 to 10.

(1) Basic Composition Member

As shown in FIGS. 1 to 3, a display device X for the game machines is comprised of a flexible EL element sheet 1 having a curved surface portion and support plates 2, 3, which are formed in the shape of a plate, covering inner side and outside of the EL element sheet 1 as a whole.

In addition, the EL element sheet 1 is preferably made of transparent resin material (film using the transparent resin material of a high polymer), being wrapped in the sticking-by-pressure state as a whole. Moreover, the outer shape-support plate 3 is transparent at least in order to demonstrate the function as a display part.

(2) Structure of EL Element Sheet

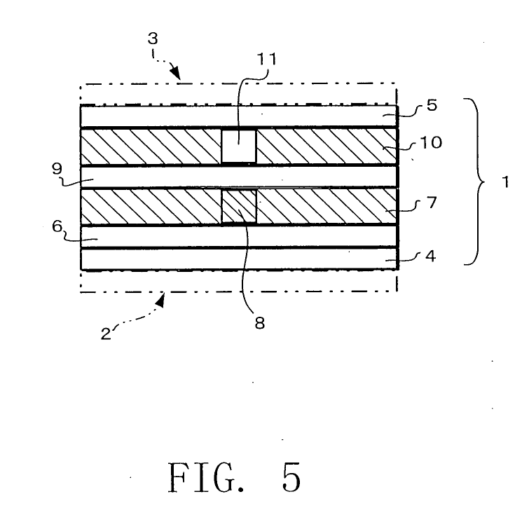

First, the structure of EL element sheet 1 is explained in reference with FIG. 5. FIG. 5 illustrates a conceptual figure showing the relation between the inner and outer shape-support plates 2, 3 and the EL element sheet 1. The EL element sheet 1 in FIG. 5 shows one part (one pixel). The EL element sheet 1 is a flexible laminating body which has a pair of electrodes, sealing by inner and outer sealing films 4, 5 after the metallic mold process and sticking-by-pressure process, etc. (is not illustrated) are operated.

The reference numeral 6 designates a first electrode covered by the inner sealing film 4, and the first electrode 6 is transparent. The reference numeral 7 designates an electro luminescent layer which has the insulated layer 8 thereinto, and the electro luminescent layer 7 defines a luminescence layer. Therefore, the insulated layer 8 defines as a portion of non-emitting light. The reference numeral 9 designate a second electrode which faces to the first electrode 6, and the second electrode 9 defines as a dielectric layer. The reference numeral 10 designates a pattern film which is covered by the outer sealing film 5. The pattern film 10 has a conductor 11. In addition, the transparent printing layer, the adhesion layer, the barrier layer which intercepts steam, the printed circuit board which has a lead terminal which are not illustrated are suitably provided in the EL element sheet 1.

(3) EL Element Sheet 1 as an Information Display Part

The EL element sheet 1 designates the information display part which can display information at the whole part thereof by the arranging pattern of the image element when it connects to the control means which is not illustrated. That is, the EL element sheet 1 allows the luminous layer eliminate according to the image pattern by impressing an electric field of alternating current between the first electrode and second electrode via lead terminal. In specially, the EL element sheet in this embodiment includes a first display part which is formed in the shape of a cross-sectional arc, allowing a plurality of rotation reels give pseudo displaying and a second display part for displaying different contents from the rotation reels on a flat part thereof.

In FIG. 1, the slash line shows the portion (information area) of the information display part for convenience of explanation. The information display part in this embodiment is distinguished to two kinds of parts at least.

One of the information display parts designates the first display part 15 with a curved surface. This first display part 15 can display two or more rotation reels along with the winning-a-prize line of the symbol, which is not illustrated, provided at the EL element sheet 1, shape-support plate and the like. Of course, the winning-a-prize line can also be displayed on the first display part 15 by a luminosity means. It depends on a display control means to process the data and the data of a memory part which connects with a control means electrically when the luminosity means is operated during winning a prize.

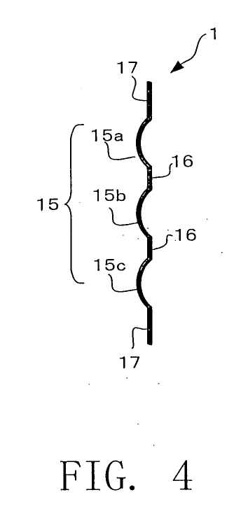

In this first embodiment, based on FIG. 4, the plurality of the first display parts 15 (three parts in total) are formed continuously via a short vertical portion 16 to the direction of a vertical axis. These first display parts 15a, 15b and 15c correspond when the three number of the rotation reels of a slot machine are arranged in a predetermined direction.

The short vertical portion 16 designates a third display part used in order to display the different information about colors, patterns, etc that differ from the first and second display parts 15, 17. The third display part 16 exists in the elongate shape respectively between the upper first display part 15a and lower first display part 15c, based on the oblong-like first display part 15b, which is formed in the shape of a long sideways, which is positioned at the central part as shown in FIG. 1.

Another information display part designates the second display part 17. This second display part 17 includes the flat portion which connects to the upper end portion of the first display part 15a and the flat portion which connects to the lower end portion of the first display part 15c in this embodiment (two pieces in total).

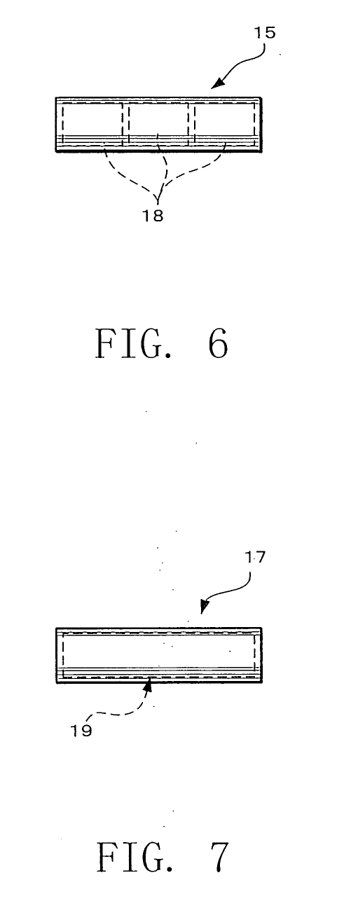

By the way, in this embodiment, the information display part has at least two or more kinds of pixel patterns. Therefore, as shown in FIG. 6, the pixel pattern 18 of the first display part 15 defines a plurality (for example, three pieces) of individual-typed patterns (for example, individual area such as a square, rectangle and round shape) which put side by side in the transverse direction. Therefore, when one number, sign, pattern, etc. are displayed respectively, it is suitable for the individual typed-pixel pattern 18. That is, when it is suitable when one symbol of the rotation reel is displayed.

On the other hand, the end pixel pattern 19 of the second display part 17 is defined by the pattern with a horizontal series, as shown in FIG. 7. Therefore, it is suitable for the end pixel pattern 19 when the narrative document is displayed. That is, when the information that differs from the symbols such as game information, stand exchange information and maintenance information on a stand or the like.

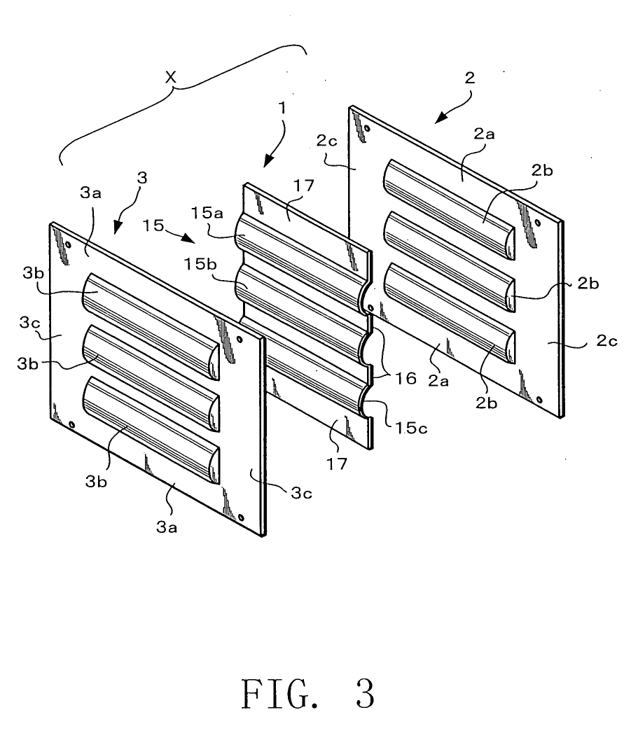

The first display part 15 is formed in the shape of a “steamed fish paste”, which looks like a shape which is cut the hollow cylinder in half so that it fits between the shape-support plates 2, 3 (so as not to produce wrinkle) as shown in FIG. 3. Moreover, for the inner and outer sealing films 4, 5, it may not be limited in the resin material when it has flexibility and high polymers. For example, it is made of a fluoric resin, polyethylene, polypropylene, polyvinyl chloride and the like.

(4) Shape-Support Plate

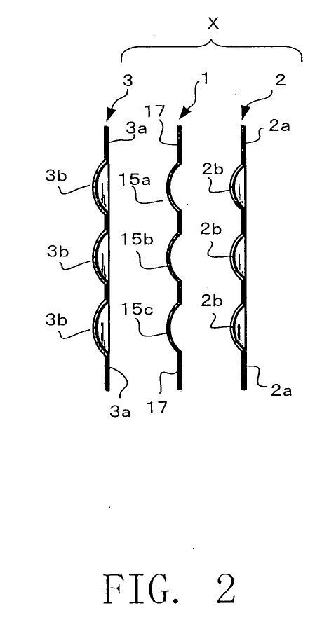

The inner and outer shape-support plates 2, 3 are formed of transparent resin plates which cover the flexible EL element sheet 1 as a whole. As shown in FIG. 2, the cross-sectional form of the inner and outer shape-support plates 2, 3 have the same shape as that of the EL element sheet 1. Therefore, the shape-support plates 2, 3 include the flat portions 2a, 3a and the curved surface portions 2b, 3b which connect to the flat portions respectively. Moreover, the curved surface portions 2b, 3b designate the cover parts, which is formed in the shape of a “steamed fish paste”, which looks like a shape which is cut the hollow cylinder in half, and the first display part 15 with a cross-sectional arc shape of the EL element sheet covers the cover parts 2b, 3b.

That is, the first display part 15 of the EL element sheet 1 is installed into the curved surface portions 2b, 3b of the shape-support plats 2, 3, on the other hand, the second display part 17 of the EL element sheet 1 is installed into the flat portions 2a, 3a of the shape-support plats 2, 3.

Furthermore, the shape-support plates 2, 3 in this embodiment includes the attachment portions 2c, 3c which project outwardly from the position of the information display parts 15, 16 and 17 the EL element sheet. A display device X is installed fixedly in a window part 21 of the game machine Y via the attachment portions 2c, 3c.

(5) Applicable Example

The display device X for the game machines is applicable to the slot machine Y which is an example of the game machine as shown in FIGS. 8 to 10. The slot machine Y has nine mechanical rotation reels 22 in total which are arranged in the shape of a matrix to the window part 21 which is positioned in front thereof. As shown in FIG. 10, the display device X is attached to the window part 21 via a fixed means 23 including an adhesion layer, screws an the like. Then the display device X is connected to the electric circuit which consists of the input part, a control means, a memory part, a power supply, an operation part, etc. of a slot machine Y.

As mentioned above, since the display device X can demonstrate a display function by itself, it is not essentials that the slot machine Y is equipped with the rotation reel 22.

However, as shown in FIG. 10, when the slot machine Y has two or more rotation reels 22, the display device X is attached to the front part of the each rotation reel 22 via some gap. If it does so, the cover parts 2b, 3b in the shape of “steamed fish paste” has an appearance which wraps three rotation reels 22 arranged in parallel in a horizontal direction. The display device X in this embodiment wraps all the rotation reels 22 at once.

In the display device X in the first embodiment, for the vertical cross-sectional shape of the EL element sheet 1 and the shape-support plates 2, 3 as shown in FIG. 2, the length of the plane part (perpendicular part) is the same as the curvature of the curved surface part (arc part), and the plane part and curved surface part are continuing by turns from an upper end to a lower end thereof.

However, as mentioned above, the vertical cross-sectional shape of the shape-support plates 2, 3 corresponds to the curvature of the curved surface part as the first display part of the EL element sheet 1, and it may change in the possible range maintaining the form of the EL element sheet 1.

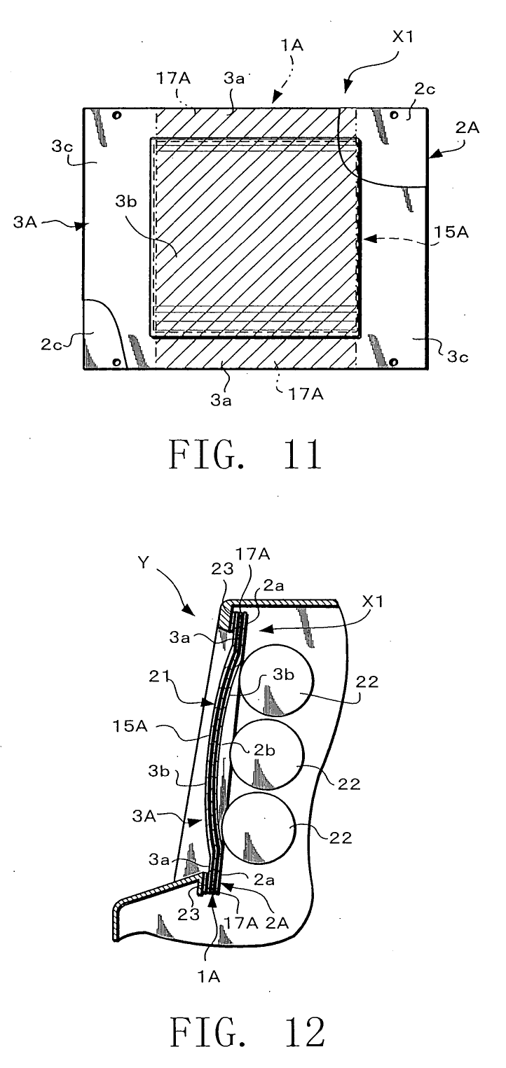

For example, FIGS. 11 and 12 illustrate the modification (second embodiment). For the display device X1 in this second embodiment, an EL element sheet 1A and shape-support plates 2A, 3A have curved surface portions 15A, 3b and 3b and flat portions 17A, 3a and 2a which connect to the curved surface portions as the display device X of the first embodiment. However, the curvature of the first display part 15A of the EL element sheet 1A of the display device X1 in the second embodiment is formed in the shape of an arc and matrix in sectional as a one so as to correspond to all of the rotation reels 22 (nine pieces) arranged at the window part 21 of the game machine Y. In addition, upper and lower second display parts 17A, 17A are connected to the both ends of the first display part 15A.

As mentioned above, the cross-sectional shape of the curved surface (arc) portion changes by the case that it corresponds individually to each rotation reel of the slot machine (first embodiment) or it corresponds on the whole to each rotation reel (second embodiment). Moreover, the sectional length of the curved surface (arc) portion changes with the radius of the rotation reel, position, number, etc.

Therefore, even though the skilled person changes the design for the curved surface (arc) portion suitably, it is an equivalent matter as long as the purpose of this invention can be reached.

As set forth above, the advantages of the invention are as follows:

(1) Since the display device, which is formed in the shape of a plate, includes one or more curved surface portions, capable of bringing the flexible EL element sheet and the inner and outer support plates which sandwiches the flexible EL element sheet as a function for displaying into action, a cubic effect comes out when a symbol is displayed on the display part of the display device, and the form of the display device does not change easily. Moreover, both of the EL element sheet and inner and outer shape-support plate have the curved parts so that “wrinkle” does not occur on the surface of the EL element sheet.

(2) Since the flexible EL element sheet is supported by the inner and outer shape-support plate, it can be attached easily to the window part of the game machine. Therefore, the attachment can be carried out in efficiency. Since the attachment part is attached to the both ends of the shape-support plate, especially invention described in claim 7, it can be set easily to the window part of the game machine using an adherence implement or adhesives.

(3) In the invention disclosed in claim 3, 5 and 6, the form of each display device is provided adequate strength.

(4) For the invention disclosed in claim 4, the control means which is not illustrated accesses the memory part and gets information, and the three-dimensional symbol (number, pattern) is displayed in the first display part as the curved surface portion. In addition, other information other than the symbol (information about the game, news information, etc.) is displayed in the second display part of the flat portion. Therefore, since the contents that are displayed are vary widely, it can double amusingness. Moreover, since the plurality of the first display parts, capable of displaying the rotation reels along with the winning-a-prize line of the symbol, are set up to the sectional direction, it is different from manufacturing the first display part individually, and it can be reduced its cost because the first display parts are formed in one step.

1-8. (canceled)

9. A display device, which is formed in the shape of a plate, for game machines comprising:
a flexible EL element sheet; and
a plurality of curved surface portions which are formed as inner and outer shape-support plates, the shape-support plates being capable forming the flexible EL element sheet therebetween forming a sandwich shaping the flexible EL element sheet for displaying information.

10. A display device for game machines according to claim 9, wherein the shape-support plates are made of a resin plate, having at least one flat portion and at least one curved surface portion which connects to the at least one flat portion.

11. A display device for game machines according to claim 9, wherein the shape-support plates have a plurality of curved surface portions that are formed continuously with a same curvature in a vertical sectional direction, an end portion of the curved surface portions forming the flat portions continuously.

12. A display device for game machines according to claim 10, wherein the shape-support plates have a plurality of curved surface portions that are formed continuously with a same curvature in a vertical sectional direction, an end portion of the curved surface portions forming the flat portions continuously.

13. A display device for game machines according to claim 9, wherein the EL element sheet further includes a first display part, which is formed in the shape of a cross-sectional arc, allowing a plurality of rotation reels to give pseudo displaying and a second display part for displaying contents that differ from the rotation reel on a flat part thereof.

14. A display device for game machines according to claim 9, wherein the shape-support plate includes a cover part which is formed in the shape of a “steam table”, having sections in the form of cylindrical segments, and the first display part formed in the EL element sheet is covered by the cover part thereof.

15. A display device for game machines according to claim 10, wherein the shape-support plate includes a cover part which is formed in the shape of a “steam table”, having sections in the form of cylindrical segments, and the first display part formed in the EL element sheet is covered by the cover part thereof.

16. A display device for game machines according to claim 11, wherein the shape-support plate includes a cover part which is formed in the shape of a “steam table”, having sections in the form of cylindrical segments, and the first display part formed in the EL element sheet is covered by the cover part thereof.

17. A display device for game machines according to claim 13, wherein the shape-support plate includes a cover part which is formed in the shape of a “steam table”, having sections in the form of cylindrical segments, and the first display part formed in the EL element sheet is covered by the cover part thereof.

18. A display device for game machines according to claim 9, wherein the flat portion which is formed in the shape-support plate covers the second display part formed in the EL element sheet.

19. A display device for game machines according to claim 10, wherein the flat portion which is formed in the shape-support plate covers the second display part formed in the EL element sheet.

20. A display device for game machines according to claim 11, wherein the flat portion which is formed in the shape-support plate covers the second display part formed in the EL element sheet.

21. A display device for game machines according to claim 12, wherein the flat portion which is formed in the shape-support plate covers the second display part formed in the EL element sheet.

22. A display device for game machines according to claim 13, wherein the flat portion which is formed in the shape-support plate covers the second display part formed in the EL element sheet.

23. A display device for game machines according to claim 14, wherein the flat portion which is formed in the shape-support plate covers the second display part formed in the EL element sheet.

24. A display device for game machines according to claim 9, further comprising:
an attachment portion which is formed in both ends of the shape-support plate, projecting in an extended direction comparing with the size of the EL element sheet.

25. A display device for game machines according to claim 9, wherein at least the outer shape-support plate is transparent.
